(19) United States
(12) Patent Application Publication
(10) Pub. No.: US 2007/0149170 A1
(43) Pub. Date: Jun. 28, 2007

(54) SIM AUTHENTICATION FOR ACCESS TO A COMPUTER/MEDIA NETWORK

(75) Inventors: Leland Scott Bloebaum, Cary, NC (US); Chuanli Liu, Chapel Hill, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/306,347

(22) Filed: Dec. 23, 2005

(51) Int. Cl. H04M 1/66

(52) U.S. Cl. 455/411

(57) ABSTRACT

A method of authenticating a portable mobile communications device for use on a computer/media network using SIM data associated with the portable mobile communications device is described. The method comprises sending SIM data from the portable mobile communications device to a mobile service provider authentication server on the mobile service provider network. The received SIM data is authenticated the using the mobile service provider's authentication server. The authenticated SIM data and an IP address are then sent to a computer/media network. A second authentication procedure is performed on the received portable mobile communications device SIM data from the mobile service provider network on the computer/media network. If successful, a hole in a firewall on the computer/media network is opened that will allow data exchanges with the portable mobile communications device using the IP address included with the authenticated SIM data received from the mobile service provider network.

### BACKGROUND OF THE INVENTION

The present invention relates to portable mobile communications devices and systems, and more particularly to a portable mobile communications device, system and method that can gain access to a computer/media network via a Subscriber Identity Module (SIM) authentication procedure using a mobile service provider (MSP) network as a proxy.

Portable mobile communications devices such as mobile phones are becoming more sophisticated and include many new features and capabilities. The portable mobile communications devices often contain powerful processing and extensive memory that allows for the performance of applications that are typically associated with larger computing devices. Such applications include, but are not limited to, music and image or video playback, text file generation or editing, e-mail messaging, and much more. Since the portable mobile communications devices are capable of such applications they are capable of using content or data files that reside on other computer/media networks.

What is needed is a mechanism or means for authenticating a portable mobile communications device to a computer/media network so that the portable mobile communications device can connect to and exchange data with the computer/media network.

### BRIEF SUMMARY OF THE INVENTION

A method of authenticating a portable mobile communications device for use on a computer/media network using SIM data associated with the portable mobile communications device is described. The method comprises sending SIM data from the portable mobile communications device to a mobile service provider authentication server on the mobile service provider network. The received SIM data is authenticated the using the mobile service provider's authentication server. The authenticated SIM data and an IP address are then sent to a computer/media network. A second authentication procedure is performed on the received portable mobile communications device SIM data from the mobile service provider network on the computer/media network. If successful, a hole in a firewall on the computer/media network is opened that will allow data exchanges with the portable mobile communications device using the IP address included with the authenticated SIM data received from the mobile service provider network.

A second method of authenticating a portable mobile communications device for use on a computer/media network using SIM data associated with the portable mobile communications device is also described. In this method a direct short range link between the portable mobile communications device and the computer/media network is established. SIM data is sent from the portable mobile communications device to the computer/media network over the established short range link. The received portable mobile communications device SIM data is authenticated by the computer/media network. If the SIM authentication is successful, the portable mobile communications device is allowed to access the computer/media network over the established short range link. The short range wireless link between the portable mobile communications device and the computer/media network can be a Bluetooth™ link, an 802.11 x WiFi link, or other suitable wireless link. The short range link between the portable mobile communications device and the computer/media network can also be a wired connection such as a serial cable.

### BRIEF DESCRIPTION OF THE DRAWINGS

FIG. 1 is a block diagram of a sample network topology for permitting a portable mobile communications device access to a computer/media network.

FIG. 2 is an alternate block diagram of a sample network topology for permitting a portable mobile communications device access to a computer/media network.

FIG. 3 is a block diagram of a typical portable mobile communications device for use with the present invention.

FIG. 4 is a flowchart describing a method for permitting a portable mobile communications device access to a computer/media network from a remote location.

FIG. 5 is a flowchart describing a method for permitting a portable mobile communications device access to a computer/media network when the portable mobile communications device is in close proximity to the computer/media network.

### DETAILED DESCRIPTION OF THE INVENTION

The present invention describes a method for authenticating a portable mobile communications device as an authorized user of a computer/media network using the subscriber identity module (SIM) data that is tied to the portable mobile communications device as a means of authenticating the user/portable mobile communications device. Upon successful authentication, the portable mobile communications device can access and exchange files and data with the computer/media network. A computer/media network may include, but is not limited to, host and client computing devices, wired or wireless network routing and switching equipment, data and/or media content storage devices, and home entertainment equipment such as televisions, stereo systems, audio/visual equipment, etc.

Portable mobile communications devices that operate on a Global System for Mobile communications (GSM) network administered by a mobile service provider (MSP) utilize a Subscriber Identity Module (SIM) card to store user specific data that is exchanged with and used by the MSP network for a variety of purposes. SIM authentication is typically used by a portable mobile communications device such as a mobile phone to authenticate itself to a mobile service provider (MSP) network. Among other things, MSP SIM authentication permits the portable mobile communications device to make and receive voice calls over the MSP network, utilize MSP data services, and allows the MSP to internally track voice and data usage for billing purposes.

The present invention presents a method for utilizing SIM authentication for another purpose, namely, as a means for authenticating a portable mobile communications device to a computer/media network (and vice versa).

Since the SIM uniquely identifies a portable mobile communications device, the SIM can potentially be used to verify permissions to access a computer/media network. In such a case, the MSP network acts as a security agent to verify the identity of the portable mobile communications device and communicate that information to the computer/media network. The computer/media network, after performing a separate authentication procedure with a mobile service provider (MSP) authentication server over an Internet Protocol (IP) network, opens a hole in its firewall to allow access by the portable mobile communications device using the IP address provided by the MSP authentication server.

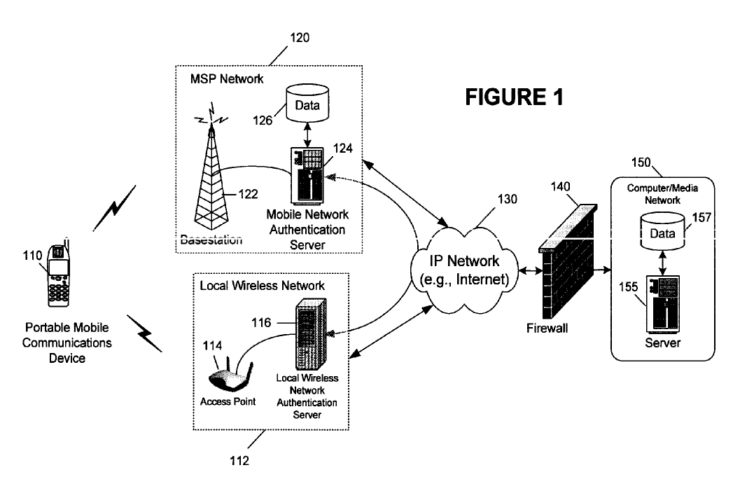

FIG. 1 is a block diagram of a sample network topology for permitting a portable mobile communications device access to a computer/media network. FIG. 1 can be viewed from left to right to show how a signal initiated by a portable mobile communications device 110 can propagate through a network (or series of networks) to a computer/media network 150. In one embodiment, the portable mobile communications device 110 is wirelessly communicable with a mobile service provider (MSP) network 120. The MSP network 120 includes a basestation 122 coupled with a computer authentication server 124 and data storage means 126. The computer server can be termed a mobile network authentication server 124 for purposes of the present invention because it will perform specific functions to assist in carrying out the present invention. The mobile network authentication server may and likely does perform a multitude of other functions within the MSP network that are not relevant to the present invention. Similarly, data storage means 126 stores data relevant to the present invention but likely also stores data relevant to other aspects of the MSP network. The components have, for illustrative purposes, been given descriptive names that pertain to their functions with respect to the present invention.

The main purpose of MSP network 120 is to serve the needs of its clients. Its clients are the portable mobile communications devices 110 that subscribe to the services offered by the MSP network 120. The most obvious service provided is the ability to make and receive voice telephony calls. The MSP network 120 also serves as a data network providing its clients the ability to send and receive data over the network. Data includes text, voice, other audio, video, etc. The MSP network is also connected with an IP network 130 such as, for instance, the Internet. By connecting with an IP network 130, the MSP network 120 is able to exchange data with other devices having a similar IP network connection. In the case of the present invention, other IP devices can include a computer/media network 150. Most computer/media networks 150 are protected from unauthorized use by a firewall 140. A firewall selectively allows data transfers to and from the computer/media network 150 based on a narrowly defined set of parameters. A common parameter is the IP address of the entity outside the firewall 140 that wishes to exchange data with the computer/media network 150. The computer/media network 150 can include a variety of peripheral devices that have been previously enumerated in a non-exhaustive and non-limiting list.

One device in particular is central to the computer/media network 150. That device can broadly be termed the local server 155. The local server 155 will act as the intelligence for the computer/media network 150 in that it will likely hold and execute software required to communicate with external devices. A device known as a wireless access point 153 may be the initial point of contact inside the computer/media network 150 firewall but will likely be under the control of the local server 155 because the home server is the device with a user interface. The local server 155 will typically take the form of a personal computer that possesses one or more network communication interfaces. The computer/media network 150 can also include data storage means 157.

In an alternative embodiment, the portable mobile communications device 110 makes its initial contact with a local wireless network 112. The local wireless network 112 includes a wireless access point 114 and a local wireless network authentication server 116. The portable mobile communications device 110 via the wireless access point can send its SIM data to the MSP network via the local wireless network.

Thus, the topology illustrated in FIG. 1 demonstrates that it is possible for a portable mobile communications device 110 to communicate from afar with a computer/media network 150. The present invention is directed toward providing an additional level of security for the benefit of the computer/media network 150 when allowing a portable mobile communications device 110 access to the computer/media network 150 using an authentication process in a novel way.

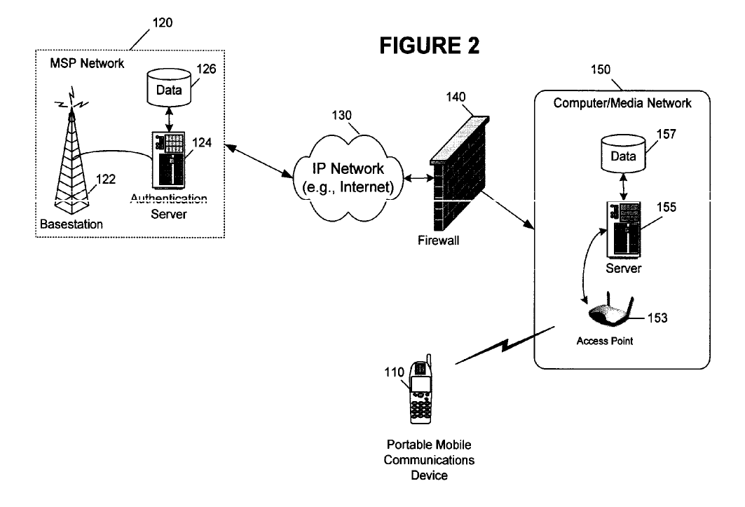

FIG. 2 is an alternate block diagram of a sample network topology for permitting a portable mobile communications device access to a computer/media network. FIG. 1 illustrated the network components that may need to be utilized to establish a link between a portable mobile communications device 110 and a computer/media network 150 when the portable mobile communications device 110 is nowhere near the computer/media network 150. FIG. 2 presents an alternate topology for when the portable mobile communications device 110 is in close proximity with the computer/media network 150. The portable mobile communications device 110 is already “inside” the firewall 140. The portable mobile communications device 110 can communicate with the computer/media network 150 more directly using a short range link such as a cable, an infrared connection, or a short range wireless protocol such as Bluetooth™ or WiFi. A physical link can be established according to one of the mechanisms just described but actual substantive data exchanges can be blocked until an authentication procedure is satisfactorily completed. Once this link has been established, the computer/media network 150 can receive the SIM data from the portable mobile communications device 110 via a wireless access point 153 and communicate with the MSP network 120 via an Internet 130 connection in order to perform a SIM authentication procedure.

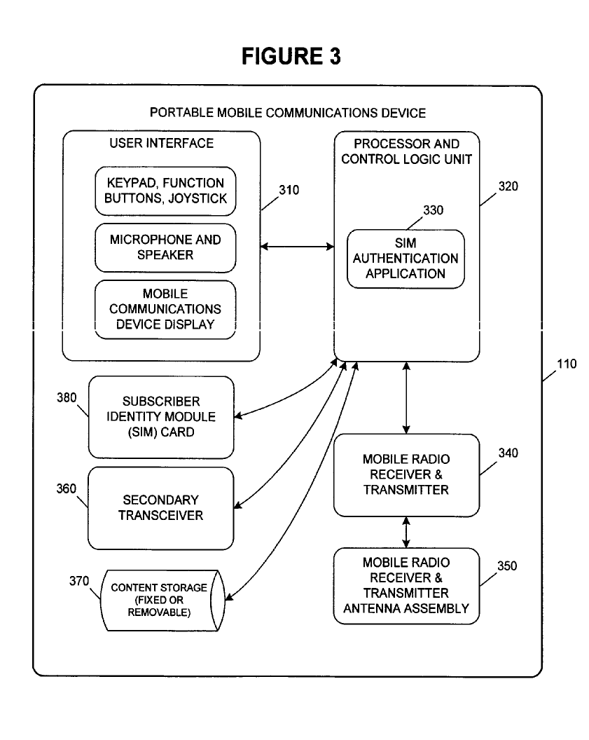

FIG. 3 is a block diagram of a typical portable mobile communications device for use with the present invention. Only the portable mobile communications device components that pertain to the present invention have been illustrated or described. The portable mobile communications device 110 may be a cordless telephone, cellular telephone, personal digital assistant (PDA), communicator, portable computer device or the like and is not unique to any particular cellular telephony communications standard, such as Advanced Mobile Phone Service (AMPS), Digital Advanced Mobile Phone Service (D-AMPS), Global System for Mobile Communications (GSM), Code Division Multiple Access (CDMA) or the like. The design of the portable mobile communications device 110 illustrated in FIG. 3 is for purposes of explaining the present invention and the present invention is not limited to any particular design.

The portable mobile communications device 110 shown in FIG. 2 may include an operator or user interface 310 to facilitate controlling operation of the portable mobile communications device 110 including initiating and conducting phone calls and other communications. The user interface 210 may include a display to provide visual signals to a subscriber or user as to the status and operation of the portable mobile communications device 110. The display may be a liquid crystal display (LCD) or the like capable of presenting color images. The display may provide information to a user or operator in the form of images, text, numerals, characters, a graphical user interface (GUI) and the like. The display may also be used to present programming carried by the mobile television broadcast signals.

The user interface 310 may also include a keypad and function keys or buttons including a pointing device, such as a joystick or the like. The keypad, function buttons and joystick permit the user to communicate commands to the portable mobile communications device 110 to dial phone numbers, initiate and terminate calls, establish other communications, such as access to a mobile TV provider, the Internet, send and receive email, text messages and the like. The keypad, function buttons and joystick may also be used to control other operations of the portable mobile communications device 110. The keypad, function buttons and joystick may also be implemented on a touch sensitive display adapted to receive tactile input.

The display, keypad, and function buttons are coupled with a main processor and control logic unit 320. The processor and control logic unit 320 may be a microprocessor or the like. The processor and logic unit 320 further includes a SIM authentication application 330 that is responsible, at least with respect to the present invention, for authenticating the portable mobile communications device 110 to the MSP network 120.

The SIM authentication detection application 330 may be embodied in hardware, firmware, software (data structures) or combinations thereof. The processor and logic unit 320 may also include other data structures, software programs, computer applications and the like to encode and decode control signals; perform communication procedures and other functions as described herein.

The user interface 310 may also include a microphone and a speaker. The microphone may receive audio or acoustic signals from a user or from another acoustic source. The microphone may convert the audio or acoustic signals to electrical signals. The microphone may be connected to the processor and logic unit 320 wherein the processor and logic unit 320 may convert the electrical signals to baseband communication signals. The processor and control logic unit 320 may be connected to a mobile radio transmitter and receiver 340 that may convert baseband signals from the processor and control logic unit 320 to radio frequency (RF) signals. The mobile radio transmitter and receiver 340 may be connected to an antenna assembly 350 for transmission of the RF signals to a communication medium or system, such as the MSP network 120 or the like.

The mobile radio antenna assembly 350 of portable mobile communications device 110 may receive RF signals over the air and transfer the RF signals to a mobile radio receiver and transmitter 340. The mobile radio receiver and transmitter 340 may convert the RF signals to baseband signals. The baseband signals may be applied to the processor and control logic unit 320 which may convert the baseband signals to electrical signals. The processor and control unit 320 may send the electrical signals to the speaker 216 which may convert the electrical signals to audio signals that can be understood by the user.

The portable mobile communications device 110 may also include a separate secondary transceiver 360 and secondary transceiver antenna assembly 260 to assist in the sending and receiving of short range wireless signals. The secondary transceiver 250 may be a Bluetooth™ device or other short range wireless transceiver including, but not limited to, 802.11x, WiFi, Ultrawide Band (wireless USB), or the like.

The portable mobile communications device 110 also includes content storage means 370 that can be fixed internally (RAM, ROM, Flash memory) or removable (Compact Flash Card, Memory Stick™, etc.)

The portable mobile communications device 110 also includes a subscriber identity module (SIM) card 380 that is coupled with the processor and control logic unit 320. The SIM card 380 possesses data pertaining to the identity of the portable mobile communications device 110, the identity of the subscriber, data pertaining to the level and types of services subscribed to, passcodes, and additional memory capacity. The additional memory capacity is typically used to store contact data for other people or entities.

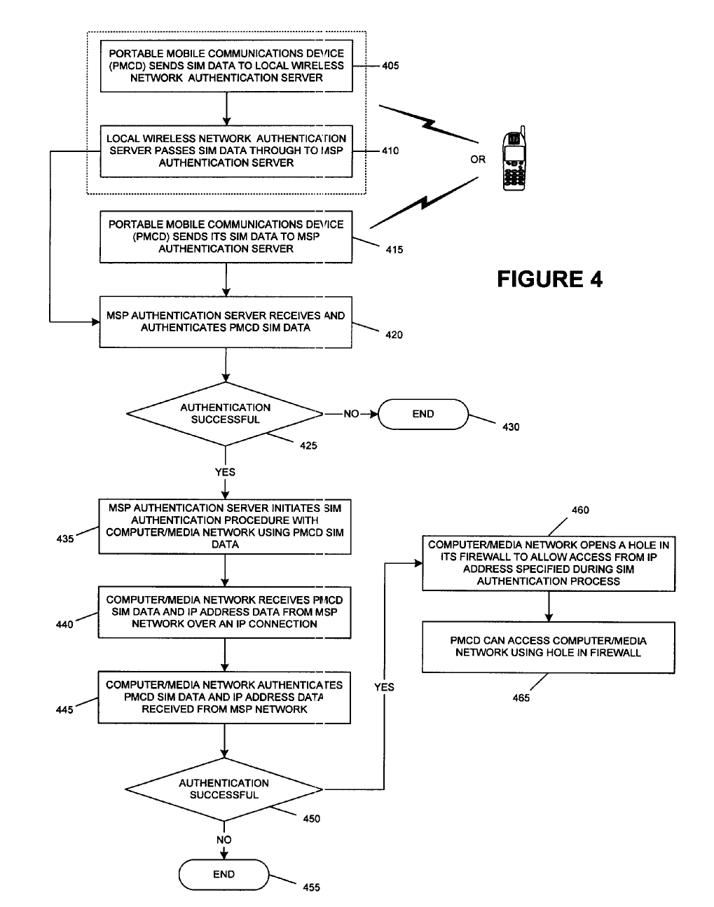

FIG. 4 is a flowchart describing a method for permitting a portable mobile communications device access to a computer/media network from a remote location. In one embodiment, the portable mobile communications device initiates contact indirectly with the mobile service provider network via a local wireless network. In block 405, the portable mobile communications device sends its SIM data to an authentication server on the local wireless network. In block 410, the local wireless network passes through the SIM data to the MSP authentication server via an Internet connection. In an alternative, the portable mobile communications device initiates contact directly with the mobile service provider network based on a desire to access a computer/media network. This is illustrated in block 415 where the portable mobile communications device sends its SIM data to an authentication server on the mobile service provider network directly.

In block 420, the MSP authentication server receives and attempts to authenticate the portable mobile communications device SIM data against its own stored repository of valid subscriber SIM data. Authentication can be performed pursuant to a GSM SIM challenge which is the exchange of various messages between the portable mobile communications device and the MSP authentication server. A GSM SIM challenge is part of the GSM technical specification standard and is well known in the art.

In block 425, the authentication results are acted upon. If the authentication procedure was unsuccessful the attempt to connect the portable mobile communications device to a computer/media network is terminated 430. Otherwise, the MSP authentication server initiates, in block 435, a separate SIM authentication procedure with the desired computer/media network by sending the previously authenticated portable mobile communications device SIM data and an IP address to a server on the computer/media network. In block 440, the computer/media network server receives the previously authenticated portable mobile communications device SIM data and IP address from the MSP authentication server. In block 445, the computer/media network server then checks the received SIM data against its own stored SIM data profile(s) to determine whether the SIM data corresponds to a device having authority to access the computer/media network. If the second authentication procedure result 450 fails to yield a match and is unsuccessful, access to the computer/media network will be denied 455. If successful, however, the computer/media network will open a hole in its firewall 460 to allow data exchanges 465 with the portable mobile communications device using the IP address specified by the MSP authentication server.

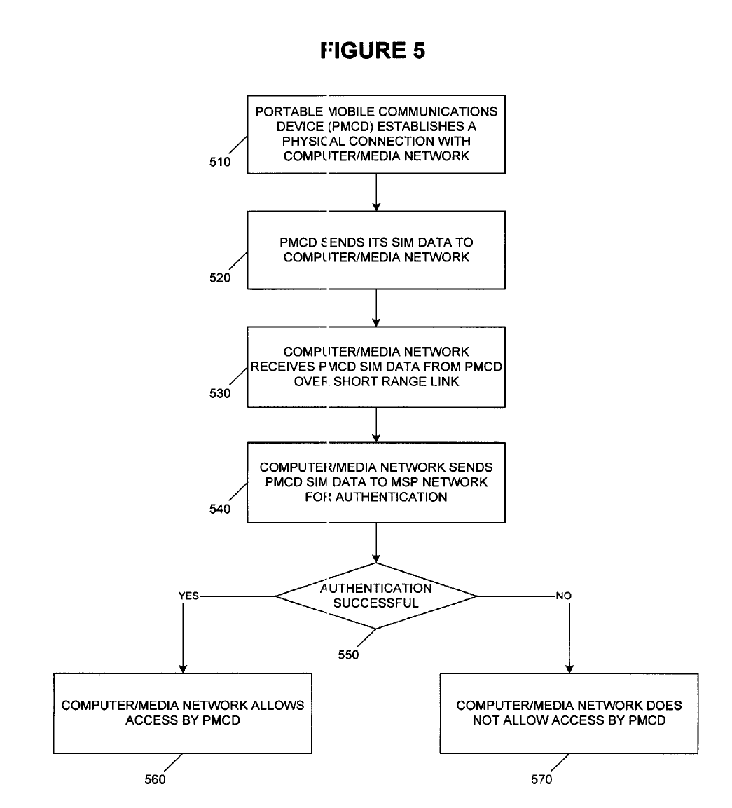

FIG. 5 is a flowchart describing a method for permitting a portable mobile communications device access to a computer/media network when the portable mobile communications device is in close proximity to the computer/media network. Close proximity means that any access to the computer/media network is direct (no intervening network such as the Internet) and already within the firewall of the computer/media network. In block 510, the portable mobile communications device establishes a connection or link capable of exchanging data with the computer/media network. The connection can be wired (e.g., USB, serial cable, etc . . . ) or wireless (e.g., Bluetooth™, WiFi, etc . . . ). In block 520, the portable mobile communications device sends its SIM data over the established connection to a server on the computer/media network. The computer/media network server receives 530 and performs an authentication procedure 540 on the SIM data by sending the received SIM data to the MSP network. The MSP network will perform the SIM authentication 540 and return the results to the computer/media network. If the authentication procedure is successful in block 550, the computer/media network allows access to its network to the portable mobile communications device 560. If the authentication procedure is unsuccessful in block 550, however, the computer/media network will not allow access to its network to the portable mobile communications device 570.

If the portable mobile communications device has been authenticated and granted access to the computer/media network via the methods described in FIG. 4 or 5, the portable mobile communications device is free to browse the computer/media network. The computer/media network can still safeguard specific files or content by associating a SIM data flag with the file(s) or content. The SIM data flag can indicate whether the file or content is to be made available to the portable mobile communications device.

Any prompts associated with the present invention may be presented and responded to via an interactive voice feature, a graphical user interface (GUI) presented on the display of the portable mobile communications device or the like.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of authenticating a portable mobile communications device for use on a computer/media network using SIM data associated with the portable mobile communications device, the method comprising:
sending SIM data from the portable mobile communications device to a mobile service provider authentication server on a mobile service provider network;
authenticating the received portable mobile communications device SIM data using the mobile service provider authentication server;
sending the authenticated SIM data for the portable mobile communications device and an IP address to the computer/media network sought to be accessed by the portable mobile communications device;
authenticating the received portable mobile communications device SIM data from the mobile service provider network on the computer/media network; and
opening a hole in a firewall on the computer/media network that will allow data exchanges with the portable mobile communications device using the IP address included with the authenticated SIM data received from the mobile service provider network.

2. The method of claim 1 wherein the step of sending SIM data from the portable mobile communications device to a mobile service provider authentication server on a mobile service provider network sends the SIM data directly from the portable mobile communications device to the mobile service provider network.

3. The method of claim 1 wherein the step of sending SIM data from the portable mobile communications device to a mobile service provider authentication server on a mobile service provider network sends the SIM data indirectly from the portable mobile communications device to the mobile service provider network by way of a local wireless network.

4. A method of authenticating a portable mobile communications device for use on a computer/media network using SIM data associated with the portable mobile communications device, the method comprising:
establishing a short range link between the portable mobile communications device and the computer/media network;
sending SIM data from the portable mobile communications device to the computer/media network over the established short range link;
sending SIM data from the computer/media network to a mobile network service provider;
authenticating the received SIM data from the computer/media network; and
allowing the portable mobile communications device to access the computer/media network over the established short range link if the SIM authentication is successful.

5. The method of claim 4 wherein the short range link between the portable mobile communications device and the computer/media network is a wireless link.

6. The method of claim 5 wherein the short range wireless link between the portable mobile communications device and the computer/media network is a Bluetooth™ link.

7. The method of claim 5 wherein the short range wireless link between the portable mobile communications device and the computer/media network is a 802.11x WiFi link.

8. A computer program product embodied on a computer readable storage medium for authenticating a portable mobile communications device for use on a computer/media network using SIM data associated with the portable mobile communications device, the computer program product comprising:
computer program code for sending SIM data from the portable mobile communications device to a mobile service provider authentication server on the mobile service provider network;
computer program code for authenticating the received portable mobile communications device SIM data using the mobile service provider authentication server;
computer program code for sending the authenticated SIM data for the portable mobile communications device and an IP address to the computer/media network sought to be accessed by the portable mobile communications device;
computer program code for authenticating the received portable mobile communications device SIM data from the mobile service provider network on the computer/media network; and
computer program code for opening a hole in a firewall on the computer/media network that will allow data exchanges with the portable mobile communications device using the IP address included with the authenticated SIM data received from the mobile service provider network.

9. A computer program product embodied on a computer readable storage medium for authenticating a portable mobile communications device for use on a computer/media network using SIM data associated with the portable mobile communications device, the computer program product comprising:
computer program code for establishing a short range link between the portable mobile communications device and the computer/media network;
computer program code for sending SIM data from the portable mobile communications device to the computer/media network over the established short range link;
computer program code for sending SIM data from the computer/media network to a mobile network service provider;
computer program code for authenticating the received SIM data from the computer/media network; and
computer program code for allowing the portable mobile communications device to access the computer/media network over the established short range link if the SIM authentication is successful.

10. The computer program product embodied on a computer readable storage medium of claim 9 wherein the short range link between the portable mobile communications device and the computer/media network is a wireless link.

11. The computer program product embodied on a computer readable storage medium of claim 10 wherein the short range wireless link between the portable mobile communications device and the computer/media network is a Bluetooth™ link.

12. The computer program product embodied on a computer readable storage medium of claim 10 wherein the short range wireless link between the portable mobile communications device and the computer/media network is a 802.11 x WiFi link.
